(19) United States
(12) Patent Application Publication
(10) Pub. No.: US 2013/0026737 A1
(43) Pub. Date: Jan. 31, 2013

(54) FOLDABLE STAIR AND WHEELCHAIR FOR TRANSPORTING PATIENTS WITH MANUAL AND/OR PEDAL DEVICE FOR SIMULTANEOUSLY BRAKING THE BACK WHEELS AND AUTOMATIC CLOSURE DEVICE

(71) Applicant: Luigi Cesare Pizzi Spadoni, Collecchio (IT)

(72) Inventor: Luigi Cesare Pizzi Spadoni, Collecchio (IT)

(73) Assignee: SPENCER ITALIA S.R.L., Collecchio (IT)

(21) Appl. No.: 13/557,043

(22) Filed: Jul. 24, 2012

(30) Foreign Application Priority Data
Jul. 25, 2011 (IT) PR2011A000066

(51) Int. Cl. A61G 5/08

(52) U.S. Cl. 280/647

(57) ABSTRACT

The present invention relates to the field of foldable and stair wheelchairs for transporting patients provided with technical features which are able to assist in closing it and braking it, patient immobilization and cleaning of the belts. The foldable, stair wheelchair for transporting patients having a manual and/or pedal braking device and automatic closure device includes at least one pedal device for automatically closing the chair, including in turn at least one command lever that extends under a seat, having the ends hinged to the front struts of the chair in hinge points, and at least one elastic return element. Also included is a manual or pedal braking device for simultaneously braking the back wheels, including at least a tubular handle located between the back struts of the chair, at least a rod and means to impart braking on the back wheels, interposed between the handle and the back wheels themselves, joined to the rod.

The present invention finds application in the field of foldable, stair wheelchairs for transporting patients equipped with technical features which are able to assist in closure and braking.

As known, closure of said foldable chairs is manually carried out through a number of uncomfortable and troublesome operations. In fact, it is first of all necessary to manually lift the chair seat and simultaneously press it bringing into contact either the back side with the front side, in some types of chairs, or the two outer sides carrying the arm rests, in other types of chairs.

As regards to braking of the above mentioned chairs, known technologies use wheels, pivoting and/or stationary type, having conventional “pedal” braking systems, which are able to brake only one wheel at a time, also in this case, involving awkward operations, thus reducing assistance to the patient.

### DISCLOSURE AND ADVANTAGES OF THE INVENTION

The purpose of the present invention is to overcome the above shortcomings making available a chair equipped with both manual and pedal device for simultaneously braking the back wheels, and thereby the chair, and with an automatic closure device for the chair itself, with relative foot-rests and arm-rests.

The advantage of said chair consists evidently in a comfort of usage of the same with reference both to the closure operations which are simply performed by a pedal, and the simultaneous braking of the back wheels which occurs by simply lowering a handle or by acting on an additional pedal, which, in the illustrated example is a rod.

Said purposes and advantages are all achieved by the foldable wheelchair for transporting patients with manual and/or pedal braking device and automatic closure device, subject of the present invention, which is characterized by what is claimed in the claims enclosed below.

### BRIEF DESCRIPTION OF THE FIGURES

This and other characteristics will be more apparent from the following description of a preferred embodiment illustrated, merely by way of simplifying and not limiting example, in the drawings of the figures.

FIG. 1: shows a perspective view of the chair according to the present invention;

FIGS. 2 and 3: shows a perspective view of the braking steps of the chair;

FIG. 4: illustrates a detail of the braking device of the chair;

FIG. 5: represents the device of FIG. 4 in another configuration;

FIG. 6: shows a perspective view of a detail of the closure system of the chair according to the present invention;

FIG. 7: shows a perspective view of a further detail of the chair closing system;

FIGS. 8 and 9: show two enlarged partial perspective views of a detail of the chair in two different positions according to the present invention;

FIG. 10: shows in an elevation view, from left to right, closing steps of the chair;

FIG. 11: shows an enlarged partial view of a detail of the chair;

FIG. 12: shows the leg-rest device in three operative stages;

FIG. 13: shows an enlarged detail of the device of FIG. 12;

FIG. 14: shows in an exploded view a rolling device of a belt for immobilizing a patient on the chair according to the present invention;

FIG. 15: shows a perspective view of the device of FIG. 14;

FIG. 16: shows the chair back struts with two belt rolling devices applied thereto, for immobilizing a patient on the chair according to the present invention;

FIG. 17: shows in detail a belt rolling device applied to one the two back struts for immobilizing a patient's legs.

### DESCRIPTION OF THE INVENTION

Particularly referring to the figures, a foldable, stair wheelchair for transporting a patient of the type provided with front 5, 5′ and back struts 6, 6′ wheeled on suitable front, 7a, 7a′, and back wheels 7b, 7b′, a seat 10a, a back 27 and guiding grips 28, 28′, is indicate as a whole by 1.

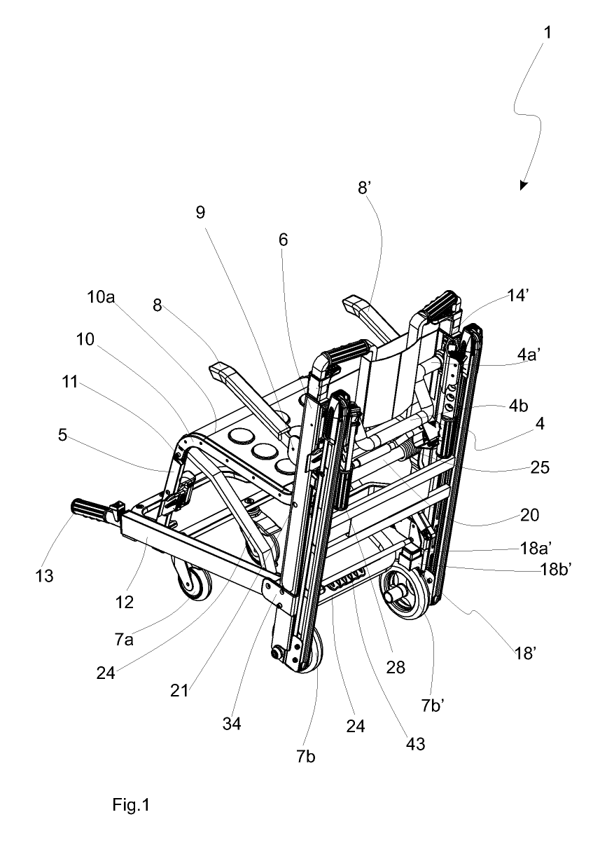

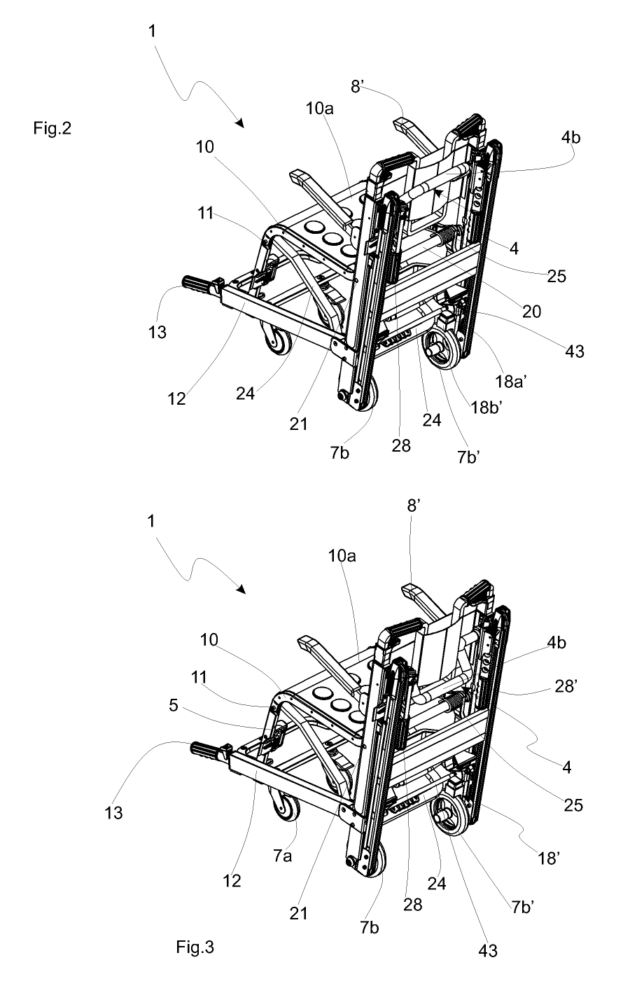

As shown in FIG. 1, said chair comprises arm-rests 8 and 8′ hinged in hinged points 9, 9′ supported by back struts 6, 6′. Each arm-rest 8, 8′, hence, can rotate upwards by a 90° angle about hinged point 9, 9′ thereof, thus defining a completely lowered first position with arm-rests 8, 8′ parallel to seat 10a of chair 1, wherein arm-rests 8, 8′ can support the patient arms, and a completely lifted second position, wherein arm-rests 8, 8′ are closed substantially parallel to the back of chair 1.

Seat 10a of chair 1, comprised of a plane, is supported by two rods 10, 10′ keyed on a bar 20, interposed between them and hinged on back struts 6, 6′ in two hinge points 21 and 21′, and which is able to rotate about its own longitudinal axis.

In an open configuration, said seat 10a is parallel to arm-rests 8, 8′ and to rods 10 and 10′, hinged on one side to back struts 6, 6′ in hinge points 11 and 11′; said seat 10a, arm-rests 8,8′ and rods 10, 10′ being substantially orthogonal to backs struts 6, 6′.

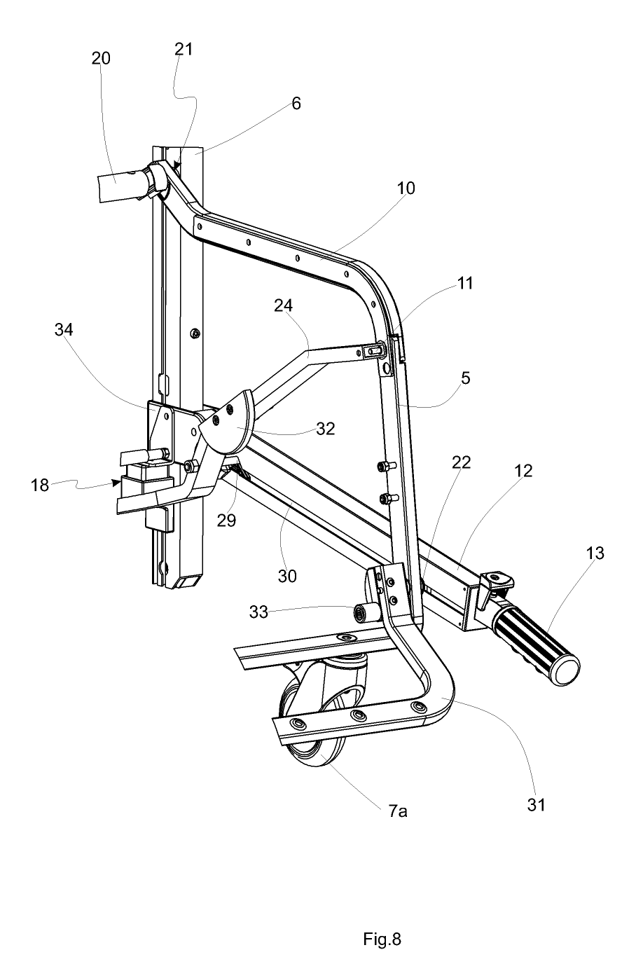

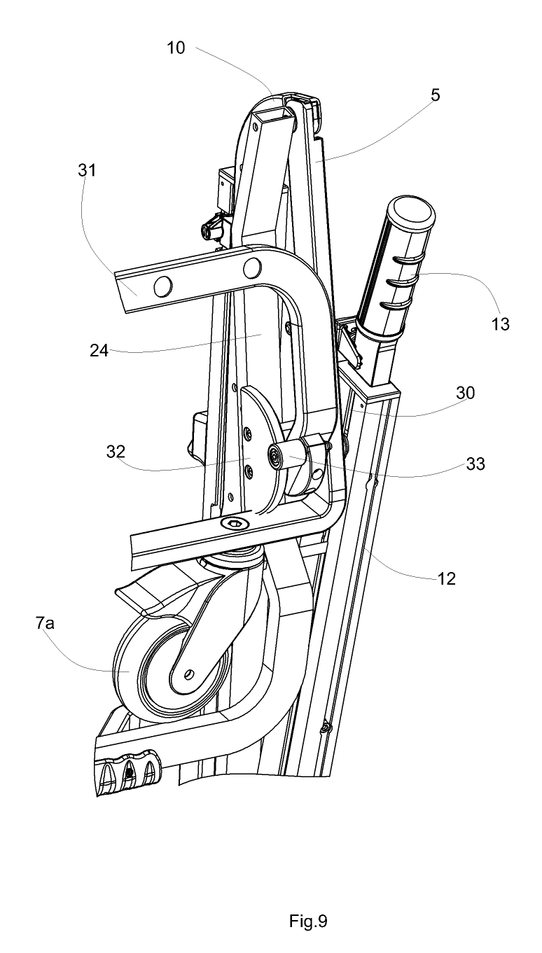

As shown in FIG. 8, front struts 5, 5′ engage with two bars 12, 12′, respectively, situated below rods 10, 10′. In particular, lower end of each strut 5, 5′ carries a pawl 22, 22′ which engages and can slide within a track 30, 30′ located on the inner side of bar 12, 12′ which it is coupled to.

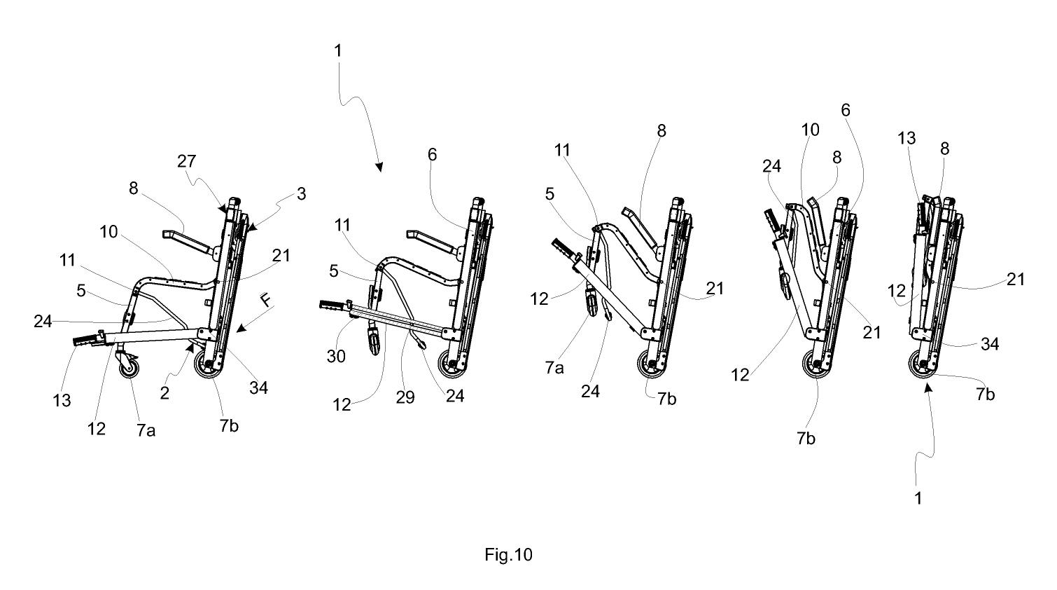

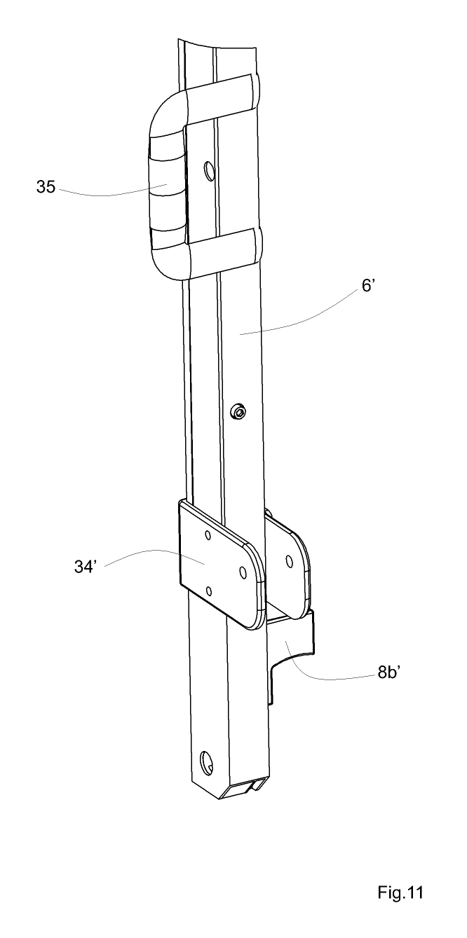

Further, each of said bars 12 and 12′ is fixed to back struts 6, 6′ by means of a U-shaped plate 34, 34′, which embraces strut 6, 6′ itself on three sides. Said bars 12 and 12′, being hinged on said plates 34, 34′, and being able to vertically rotate by 90°, can be positioned between a first operative work position, wherein bars 12, 12′ are horizontal, and a non-operative position, wherein bar 12 and 12′ are vertically positioned. Said positioning is well illustrated in FIG. 10, where, on the left side, the operative position with horizontal bars 12, 12′ is shown, and, on the left side, the non-operative position, corresponding to chair 1 closed, with bars 12, 12′ in a vertical position is illustrated.

Finally, it can be seen, that said bars 12 and 12′ each end with a handle suitable to move chair 1 with a patient seated thereon, for example, along a staircase, along which moving the chair 1 by means of wheels 7a, 7a′, 7b, 7b′ is not possible.

A foot-rest of known type, hinged at the ends to struts 5, 5′ at pawls 22, 22′ has been denoted with 31.

Chair 1 according to the present invention is provided with a manual and/or pedal braking device 3, for simultaneously braking back wheels 7b, 7b′.

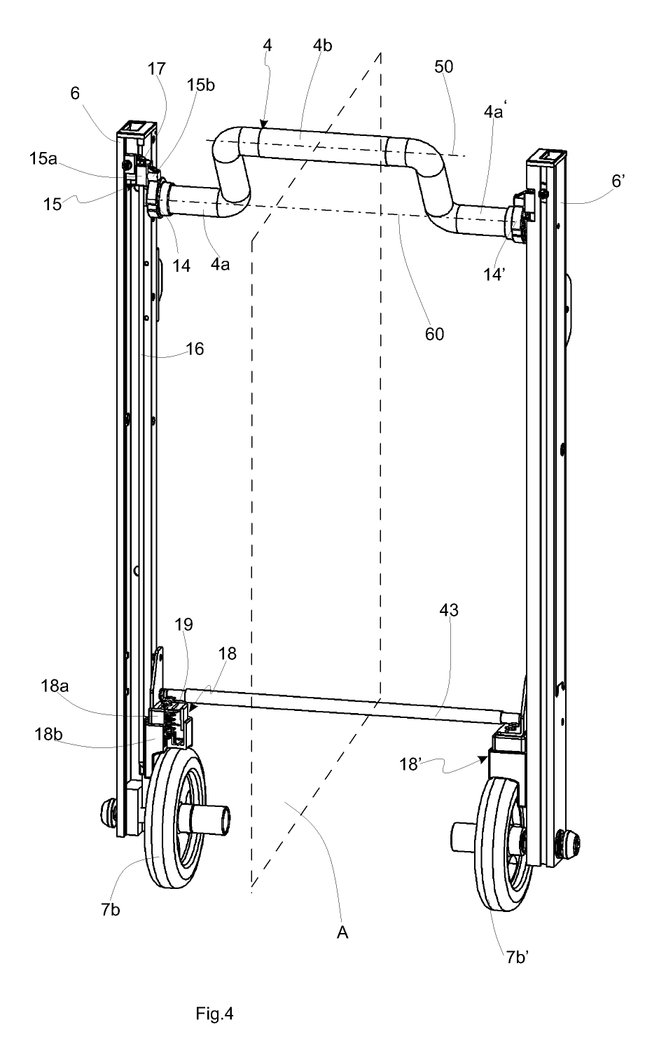

As shown in FIG. 4, said device 3 comprises in general a handle 4, having, for example, a tubular form, positioned behind the back 27 of chair 1, substantially at the height of guiding grips 28, 28′, located between back struts 6, 6′ and hinged thereto, and a rod 43, located above back wheels 7b, 7b′, acting as a pedal.

Handle 4 is substantially U-shaped and ends in two segments 4a, 4a′ disposed parallel to the central zone 4b thereof. In said handle, hence, two different axes can be recognized: a gripping axis 50, passing through central zone 4b, and an axis 60, passing by segments 4a, 4a′ and parallel to gripping axis 50, about which, under action of a force, central zone 4b rotates and, thus, handle 4 itself.

Between said handle 4 and back wheels 7b, 7b′, means for imparting braking to back wheels 7b, 7b′ themselves are interposed.

In particular, in the illustrated simplifying and non-limiting example, said means consist of a cam 14, 14′ placed on the end of each segment 4a, 4a′ of handle 4 which engages a wing 15b, 15b′ of a follower 15, 15′ made up of a pawl 15a, 15a′ and the above mentioned wing 15b, 15 b′.

For clarity, the manual braking device 3, as well as the chair 1 itself, having a symmetrical geometry with respect to a vertical plane A passing in the middle between back struts 6, 6′ and parallel therewith, in the following, reference will be made to means that impart braking to back wheels 7b, 7b′ of only a portion of braking device 3.

Pawl 15a is fixed, through a nut 17, on the upper end of a threaded rod 16 disposed within back strut 6.

Said threaded rod 16 ends on the lower side with a substantially box-like element 18 disposed above wheel 7b, made up of two portions, respectively upper 18a and lower portion 18b, within which a spring 19 is located.

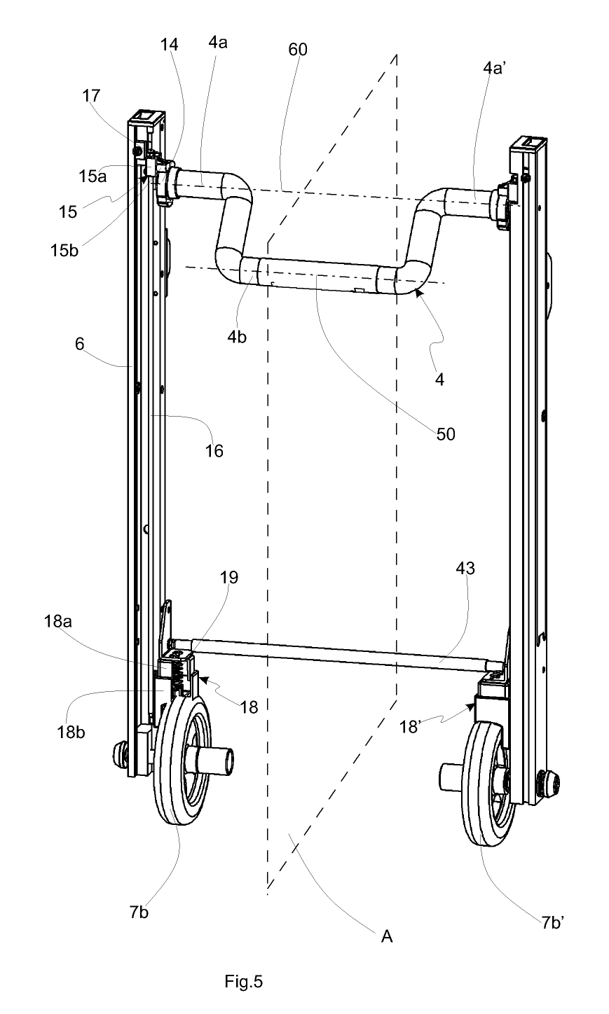

Operatively, as shown in FIG. 5, an operator willing to stop chair 1, acts on handle 4 rotating central zone 4b downwards, about axis 60 passing through segments 4a, 4a′. Subsequently, cams 14, 14′ rotate so that wings 15b, 15b′ of followers 15, 15′ travel along their idle arcs.

Threaded rods 16, 16′, by being integral with said followers 15, 15′ during their sliding along said idle arcs of cams 14, 14′, descend inside back struts 6, 6′ acting on the lower portions of box-like elements 18, 18′ which, as a result, simultaneously stop the two back wheels 7b, 7b′, braking chair 1.

Springs 19, 19′ located within box-like elements 18, 18′ are needed when releasing chair 1 disengaging back wheels 7b, 7b′ is desired. For a better explanation, by rotating central zone 4b upwards about axis 60, cams 14, 14′ rotate so that wings 15b, 15b′ of followers 15, 15′ travel their lifts. As a result, rods 16, 16′ are lifted along with lower portions 18b, 18b′ of box-like elements 18, 18′, assisted by spring 19, 19′ thrust (FIG. 4).

Alternatively, an operator can simultaneously brake back wheels 7b, 7b′ acting on rod 43, being integral by the ends with lower 18a and upper portion 18b of box-like elements 18, 18′.

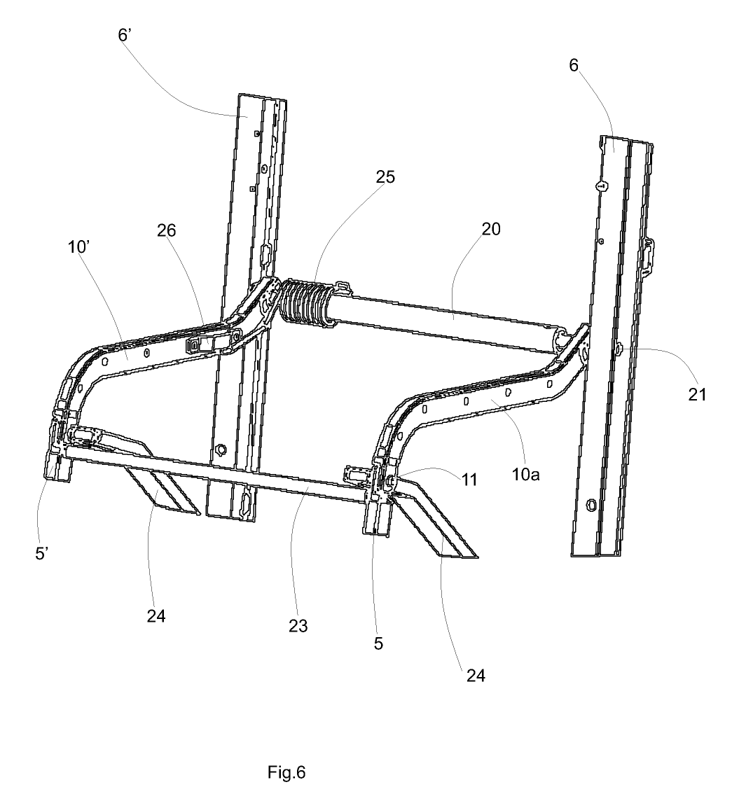

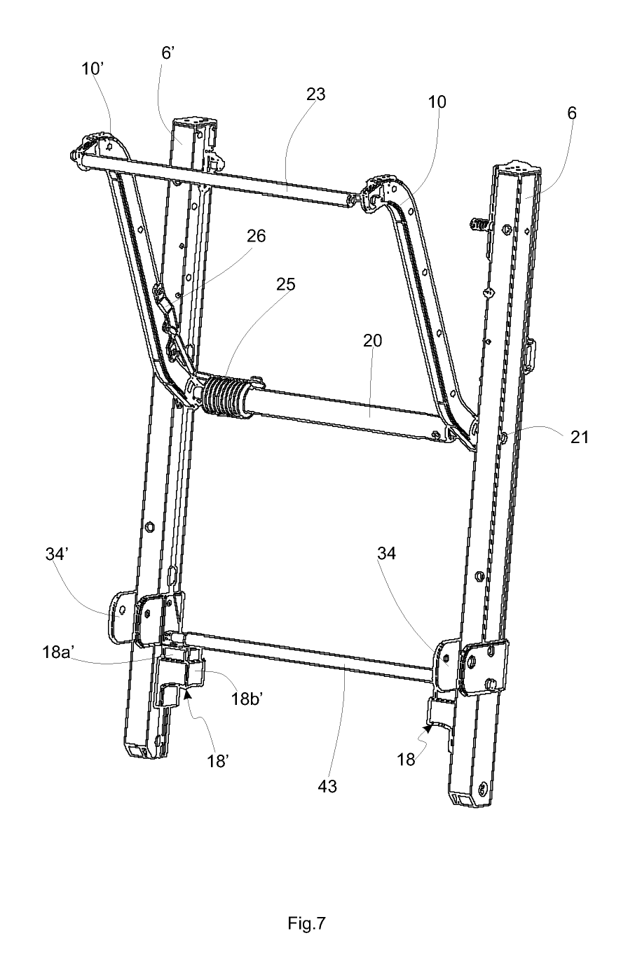

Chair 1 according to the present invention, as illustrated in FIGS. 1, 6, and 7, comprises a command lever 24, substantially U-shaped, hinged at the ends in two hinge points 11, 11′. In particular, said command lever 24, which extends below seat 10a of chair 1, approximately by ⅔ of its own length, starting from said hinge points 11, 11′, carries on each side a pin 29, 29′ which engages track 30, 30′ made in each bar 12, 12′ (FIG. 8). Said solution, in conclusion, makes command lever 24 hinged in four points 11, 11′, 29, 29′.

As well noticeable in FIG. 8, foot-rest 1 has, on at least one of the two ends, a small wheel 33, which, together with a cam 32 fixed to lever 24, forms a device, which will be discussed in greater detail later, suitable for automatically closing foot-rest 31 itself during closure of chair 1 itself.

Below hinge points 11, 11′, a small bar 23 is arranged between back struts 5, 5′ and parallel to bar 20. Seat 10a is attached to said bar 23.

An elastic member, applied to at least one of the two bars 10 and/or 10′, and arranged to operate device 2, is indicate at 25. Such operation will also be described in greater detail in the following.

Specifically, in the illustrated example, said elastic member 25 is a spring, keyed on bar 20 and coupled to rod 10′ through a slot 26 applied on rod 10′ itself.

Finally, to make chair 1 more easily portable by an operator, in the closed, non-operative position, at least a grip (35) fixable to at least one of the two back struts 6, 6′ is provided. By means of said grip 35, the operator is able to carry chair 1 grasping and holding orthogonally with respect to his/her arm.

Operatively, as shown in FIG. 10, the operator applies directly, with one foot, a force F on command lever 24. Said force F causes command lever 24, in addition to rotate about hinge points 11, 11′, to transmit a component of force F to seat 10a supporting rods 10 and 10′. A rotation of said rods 10 and 10′ about hinge points 21, 21′ is triggered, and, as a result, of back struts 5, 5′ hinged thereto in hinge points 11, 11′, such rotation is further assisted by pulling action exerted by spring 25 on rod 10′ itself.

As spring 25 returns rods 10′, said rods 10 and 10′ rotate about hinge points 21 e 21′, and command lever 24, now released, also rotates about hinge pints 11, 11′. Obviously, in doing so, pins 29 and 29′ slide inside tracks 30 and 30′, respectively.

The above mentioned rotation causes also front struts 5, 5′ to rotate about hinge points 11, 11′ causing rotation of bars 12, 12′ the struts are connected to by means of pawls 22 e 22′ which translate within the above mentioned tracks 30 and 30′ respectively.

Lifting of seat 10a forces arm-rests 8, 8′ to rotate upwards about hinge points 9, 9′.

Finally, when struts 5, 5′, in virtue of rotation, are approximately parallel to command lever 24, wheel 33 of foot-rest 31 engages cam 32 of command lever 24. Wheel 33, then, rolling on said cam 32 profile, causes foot-rest 31 to automatically close.

Once rotation of seat 10a, front strut 5, 5′, bars 12, 12′, arm-rests 8, 8′ and foot-rest 31 has ended, chair 1 is in a folded closure position, illustrated in FIG. 10.

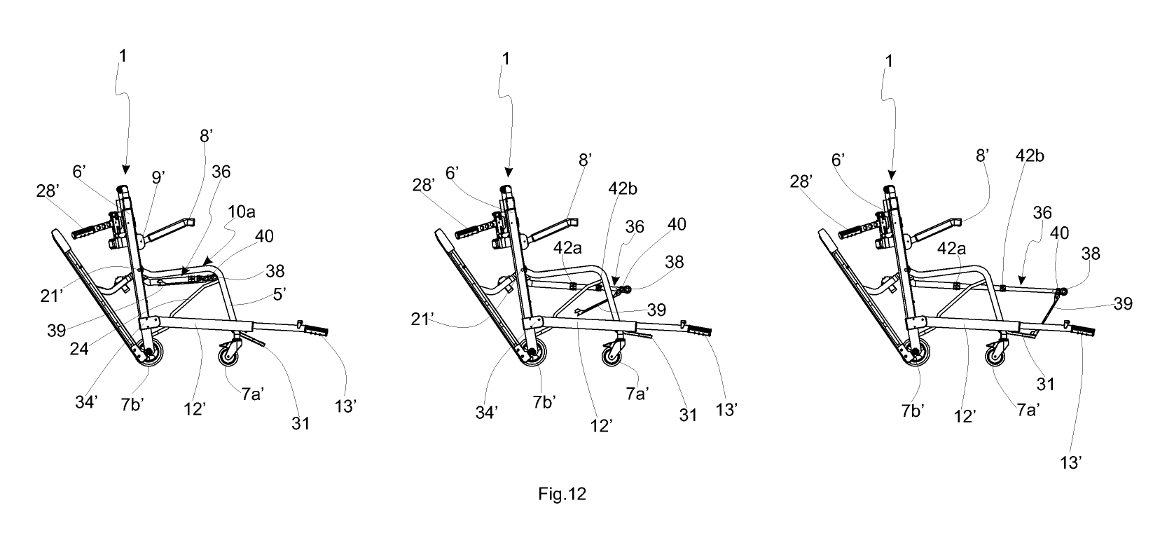

As shown in FIG. 12, said foldable, stair wheelchair 1 for transporting patients can provide at least a telescopic leg-rest 36, formed by a plurality of tubes, extensible and adjustable by means of two threaded ring-nuts 42a, 42b, disposed below seat 10a of chair 1 and hinged approximately in bar 20 median point.

Said leg-rest 36, once desired travel has been reached, is held in position by a rod 39, hinged at the end of a pin 40, passing through leg-rest 36 itself and disposed orthogonally to the same, about which it can rotate parallel to leg-rest 36 axis. In particular, said rod 39 maintains its position resting with its lower end on foot-rest 31.

At the free end, said leg-rest 36 has a joint 37, to which is integral a support 38 orthogonally located with respect to the leg rest 36 and the joint 37 itself.

Said joint 37, and thus support 38, being capable of rotating of 180° such that support 38 follows a semi circumference contained in quadrants I and II of a reference Cartesian plain.

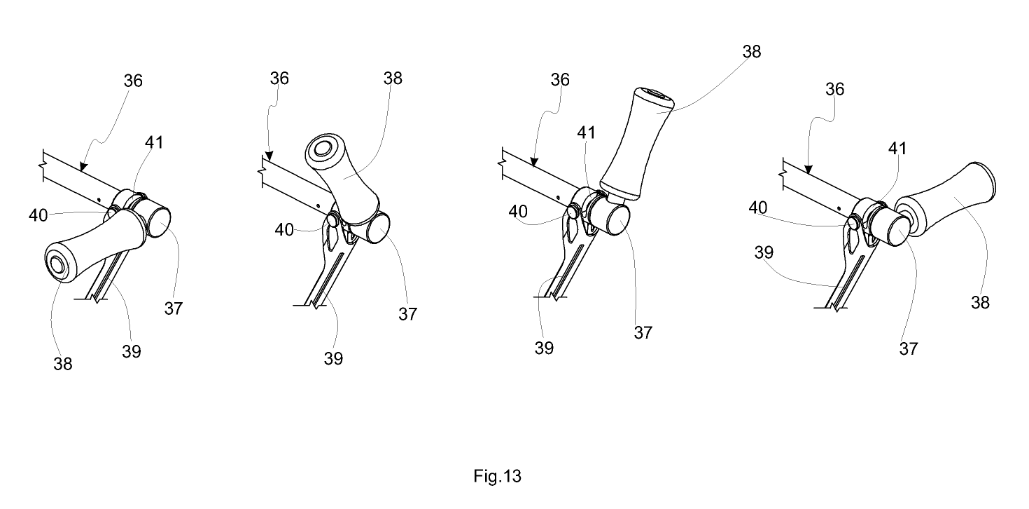

Then, according to whether a right leg or a left leg is to be supported, support 38 is rotated to one side or the other, as well shown in FIG. 13.

Further, in joint 37, a split 41 is formed within which a pin (not shown in the figure), fixed to foot-rest 1, acting as rotation retainer is inserted.

Finally, chair 1 can be equipped with one or more belt winding devices 44, of known type, needed if immobilizing the patient on the same is desired.

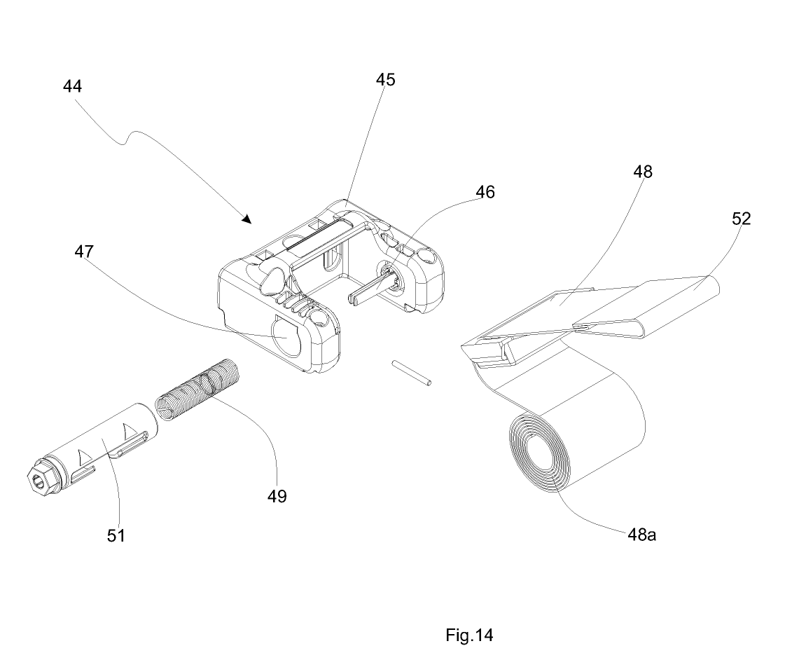

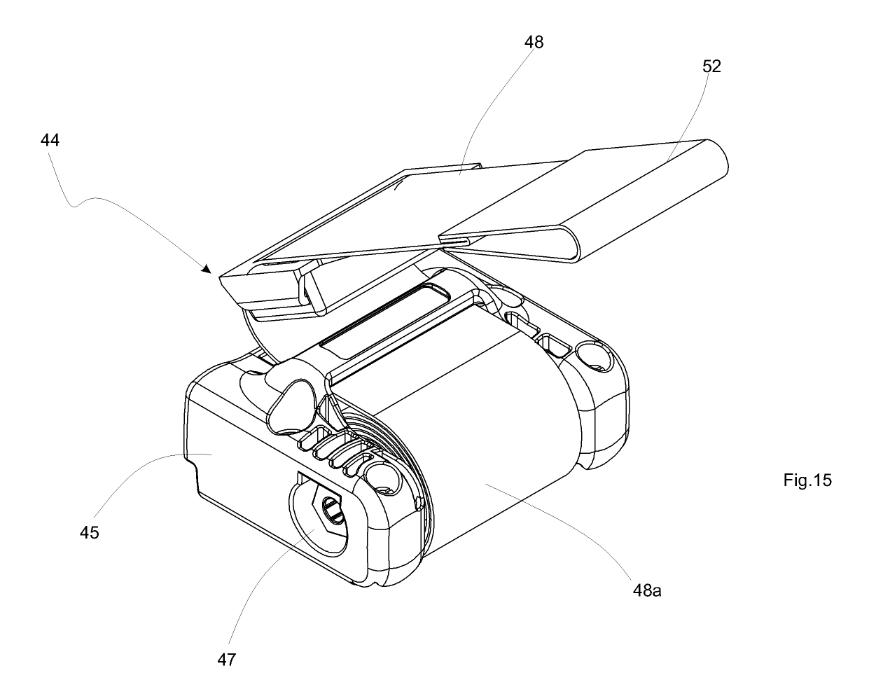

As shown in FIGS. 14 and 15, a winding device comprises a C-shaped box-like structure 45 having a pin 46 inside one of the two ends and a through hole 47 at the opposite end.

A belt 48, wound on itself to form a cylindrical body 48a, is located between the two ends of box-like structure 45, so that pin 46 is inserted therein.

In through hole 47, a spring 49 and a catch 51 are inserted inside cylindrical body 48a.

As shown in the figures, on belt 48 free end there is located a hooking means 52, which can be male or female of a spring catch of known type.

In practice, spring 49 maintains belt 48 wound on itself and functions as return element for the belt 48 itself, when this is to be rewound from stretched.

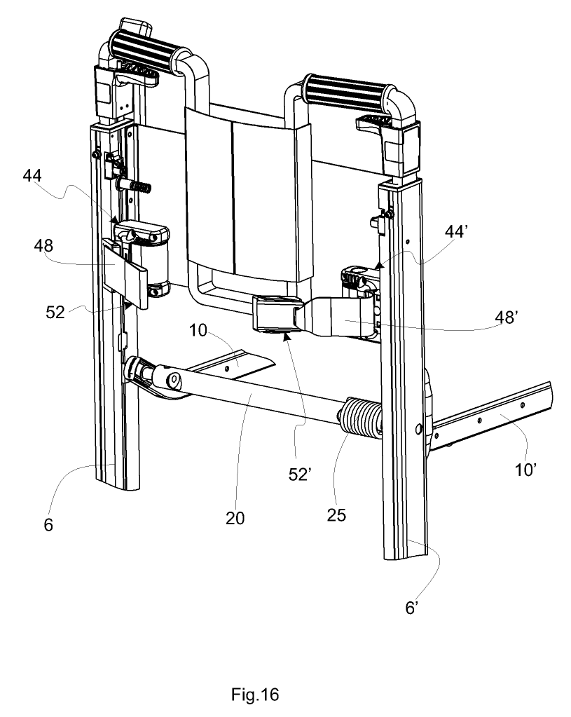

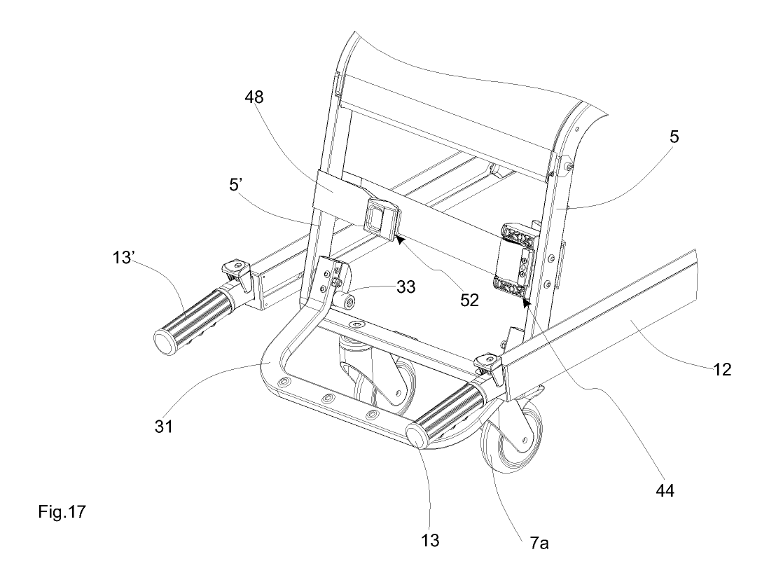

FIG. 16 shows back struts 6, 6′ of chair 1 with two winding devices 44, 44′ which are necessary if immobilizing the upper body of a patient seated on chair 1 is desired.

Also, in order to be able to retain the above mentioned patient lower limbs, at least a winding device 44 is provided applied to at least one of the two back struts 5, 5′ of chair 1.

In the description, reference has always been made to a foldable wheelchair 1, but reference can also be made to a foldable stair-chair, however falling within the scope of the invention defined in the appended claims below.

1. A foldable, stair wheelchair for transporting patients having a manual and/or pedal device for simultaneously braking back wheels and a device for the automatic closure, of the type provided with front and back struts, wheeled by suitable wheels, a seat, a back and guiding grips, comprising:
at least one pedal device for automatically closing the chair, comprising:
at least one command lever, extending under said seat, having the ends hinged to the front struts in hinge points,
at least one elastic element applied to at least one of two rods forming a seat support,
a device for simultaneously braking the back wheels, driveable by an user located behind the chair back.

2. The chair according to claim 1, wherein said braking device is manual through a handle located behind the back substantially at the same height of the guiding grips.

3. The chair according to claim 1, wherein said device for simultaneously braking the back wheels is a pedal device through a rod located behind and above the back wheels themselves.

4. The chair according to claim 1, wherein the elastic element is a spring keyed on a bar, interposed between the back struts and the rods, and is connected to at least one of said rods by at least one slot applied to the rod and/or to the rod itself.

5. The chair according to claim 1, wherein the drive lever has on each side at least a pin which engages a track made in two bars located under the rods, fixed to the back struts; said bars being journeyed on plates and being capable of vertically rotating of 90° between a first operative work position, wherein the bars are horizontal, and a non operative position wherein the bars are vertically positioned.

6. The chair according to claim 1, further comprising a footrest hinged to at least one of the two struts; said footrest being automatically closed during the closure of the chair by a closing device.

7. The chair according to claim 6, wherein said closing device comprises at least one wheel located in at least one of the two footrest ends, and at least a cam fixed to the command lever.

8. A foldable, stair wheelchair having a manual device for simultaneously braking back wheels and for automatically closing the chair for transporting patients, of the type comprising front and back struts, wheeled by suitable wheels, a seat, a back and guiding grips, comprising:
at least one manual braking device which comprises in turn at least one handle located between said back struts to the handle being hinged means for braking the back wheels, interposed between said handle and the back wheels themselves.

9. The chair according to claim 8, wherein the back wheels braking means comprise at least one cam, located at the end of each segment of the handle, which engages at least one follower to which is fixed at least one rod which ends at its bottom with a box-like element located above the back wheels to be stopped.

10. The chair according to claim 9, wherein the box-like element consists of an upper portion and a lower portion and in that there is at least one spring inside the box-like element.

11. The chair according to claim 1, further comprising a telescopic leg rest, formed by a plurality of tubes, located under the seat of the chair and hinged approximately in the intermediate point of the bar, which in the free end has a joint to which is integral a support orthogonally located with respect to the leg rest and the joint itself; said joint and support being capable of rotating of 180° so that the support follows a semi circumference contained in quadrants I and II of a reference Cartesian plain.

12. The chair according to claim 1, wherein a rod is interposed between the leg rest and the footrest; said rod having the function of supporting the leg rest itself when it has reached the desired travel.

13. The chair according to claim 1, wherein a grip is fixable to at least one of the back struts.

14. The chair according to claim 1, further comprising one or more devices for winding up belts, fixable to the back struts and/or to the front struts for immobilizing a patient on the chair itself.

15. The chair according to claim 2, wherein said device for simultaneously braking the back wheels is a pedal device through a rod located behind and above the back wheels themselves.

16. The chair according to claims claim 4, further comprising a telescopic leg rest, formed by a plurality of tubes, located under the seat of the chair and hinged approximately in the intermediate point of the bar, which in the free end has a joint to which is integral a support orthogonally located with respect to the leg rest and the joint itself; said joint and support being capable of rotating of 180° so that the support follows a semi circumference contained in quadrants I and II of a reference Cartesian plain.

17. The chair according to claim 11, wherein a rod is interposed between the leg rest and the footrest; said rod having the function of supporting the leg rest itself when it has reached the desired travel.

18. The chair according to claim 16, wherein a rod is interposed between the leg rest and the footrest; said rod having the function of supporting the leg rest itself when it has reached the desired travel.
